(19) United States
(12) Patent Application Publication
(10) Pub. No.: US 2023/0259847 A1
(43) Pub. Date: Aug. 17, 2023

(54) MANAGEMENT APPARATUS, MANAGEMENT SYSTEM, MANAGEMENT METHOD, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventors: Makoto Matsushita, Ichinomiya-shi Aichi-ken (JP); Hiroe Fukui, Toyohashi-shi Aichi-ken (JP); Naoki Uenoyama, Kasugai-shi Aichi-ken (JP); Hikaru Gotoh, Nagoya-shi Aichi-ken (JP); Satoshi Komamine, Nagoya-shi Aichi-ken (JP); Takanori Sasano, Toyota-shi Aichi-ken (JP)

(73) Assignee: TOYOTA JIDOSHA KABUSHIKI KAISHA, Toyota-shi Aichi-ken (JP)

(21) Appl. No.: 18/109,058

(22) Filed: Feb. 13, 2023

(30) Foreign Application Priority Data
Feb. 15, 2022 (JP) 2022-021556

(51) Int. Cl. G06Q 10/0631; G06Q 10/20; G06Q 10/083

(52) U.S. Cl. CPC G06Q 10/06315; G06Q 10/20; G06Q 10/083

(57) ABSTRACT

A management apparatus includes a controller that manages mobile objects that deliver articles. The controller determines a mobile object to allocate for delivery while taking into consideration the possibility that maintenance on the mobile object will become necessary during delivery.

### CROSS-REFERENCE TO RELATED APPLICATION

This application claims priority to Japanese Patent Application No. 2022-21556, filed on Feb. 15, 2022, the entire contents of which are incorporated herein by reference.

### TECHNICAL FIELD

The present disclosure relates to a management apparatus, a management system, a management method, and a non-transitory computer readable medium.

### BACKGROUND

A method of delivering goods by unmanned delivery vehicles is known. For example, see Patent Literature (PTL) 1.

### CITATION LIST

### Patent Literature

PTL 1: JP 2020-7148 A

### SUMMARY

Delivery efficiency is reduced when a mobile object used for delivery stops en route. Increasing the frequency of maintenance on mobile objects used for delivery will reduce the operating efficiency of the mobile objects. Demand exists for a balance between the frequency of maintenance on mobile objects used for delivery and the delivery efficiency.

It would be helpful to improve the balance between the frequency of maintenance on mobile objects used for delivery and the delivery efficiency.

A management apparatus according to an embodiment of the present disclosure includes a controller that manages mobile objects that deliver articles. The controller determines the mobile object to allocate for delivery while taking into consideration a possibility that maintenance on the mobile object will become necessary during delivery.

A management system according to an embodiment of the present disclosure includes the aforementioned management apparatus and a mobile object that delivers articles.

A management method according to an embodiment of the present disclosure is performed by a management apparatus configured to manage mobile objects that deliver articles. The management method includes determining, by the management apparatus, the mobile object to allocate for delivery while taking into consideration a possibility that maintenance on the mobile object will become necessary during delivery.

A non-transitory computer readable medium according to an embodiment of the present disclosure stores a management program. The management program is executed by a management apparatus configured to manage mobile objects that deliver articles. The management program causes the management apparatus to determine the mobile object to allocate for delivery while taking into consideration a possibility that maintenance on the mobile object will become necessary during delivery.

According to a management apparatus for mobile objects, a management system, a management method, and a non-transitory computer readable medium in embodiments of the present disclosure, the balance between the frequency of maintenance on mobile objects used for delivery and the delivery efficiency can be improved.

### BRIEF DESCRIPTION OF THE DRAWINGS

In the accompanying drawings:

FIG. 1 is a block diagram illustrating an example configuration of a management system according to an embodiment;

FIG. 2 is a diagram schematically illustrating an example configuration of a mobile object; and

FIG. 3 is a flowchart illustrating an example procedure of a management method according to an embodiment.

### DETAILED DESCRIPTION

(Example Configuration of Management System 1)

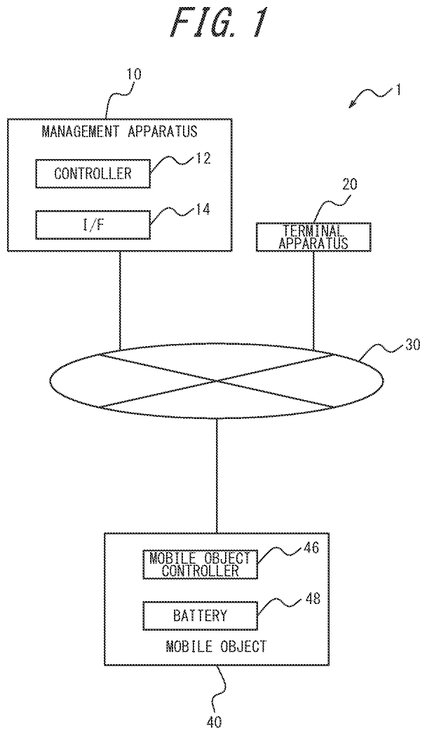

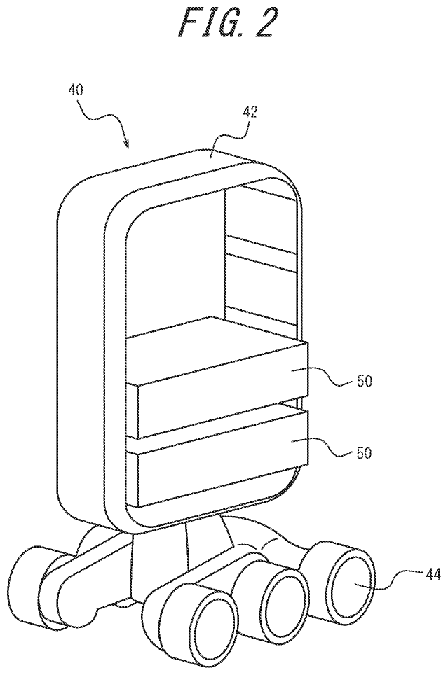

As illustrated in FIG. 1, a management system 1 according to an embodiment includes a management apparatus 10 and a mobile object 40. The mobile object 40 stores delivery articles 50 (see FIG. 2) and travels from the delivery source to the delivery destination of the delivery articles 50. The management apparatus 10 manages the operation of the mobile object 40 and allocates the mobile object 40 for the task of delivering the delivery articles 50. A specific example configuration of the management system 1 will be described below.

<Management Apparatus 10>

The management apparatus 10 includes a controller 12 and an interface 14. The interface 14 is also referred to as an I/F 14.

The controller 12 controls at least one component of the management apparatus 10. The controller 12 may be configured to include at least one processor. The “processor” is a general purpose processor, a dedicated processor specialized for specific processing, or the like in the present embodiment but is not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The management apparatus 10 may further include a memory. The memory is a semiconductor memory, a magnetic memory, an optical memory, or the like, for example, but is not limited to these. The memory may function, for example, as a main memory, an auxiliary memory, or a cache memory. The memory may include an electromagnetic storage medium, such as a magnetic disk. The memory may include a non-transitory computer readable medium. The memory stores any information used for operation of the management apparatus 10. For example, the memory may store a system program, an application program, or the like. The memory may be included in the controller 12.

Information, data, or the like is outputted from and inputted to the controller 12 through the I/F 14. The I/F 14 may include a communication module for communication with other devices, such as the mobile object 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The I/F 14 may be configured to be connected to the communication module.

The I/F 14 may be configured with an input device for receiving inputs, such as information or data, from a user. The input device may be configured with, for example, a touch panel, a touch sensor, or a pointing device such as a mouse. The input device may be configured with a physical key. The input device may be configured with an audio input device, such as a microphone.

The I/F 14 may be configured with an output device that outputs information, data, or the like to the user. The output device may include, for example, a display device that outputs visual information, such as images, characters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The management apparatus 10 may include a single server apparatus or a plurality of server apparatuses capable of communicating with each other.

<Mobile Object 40>

As illustrated in FIG. 2, the mobile object 40 includes a body 42 with a storage space for storing delivery articles 50, which are articles to be delivered, and a driver 44 for moving the mobile object 40. The storage space of the body 42 may be configured to store delivery articles 50 packed in delivery boxes or the like or may be configured to store delivery articles 50 that are not packed in delivery boxes or the like. The body 42 may be equipped with a locking mechanism configured to lock the delivery articles 50 stored in the storage space.

The driver 44 may, for example, include wheels or caterpillars as a mechanism for traveling on a road surface. The driver 44 may further include a drive mechanism such as a motor or engine that drives the wheels, caterpillars, or the like. The driver 44 may further include components such as gears that transmit power from the drive mechanism to the wheels, caterpillars, or the like. The driver 44 may further include a battery 48 (see FIG. 1) to supply power or a tank to supply fuel to the drive mechanism. In the present embodiment, the mobile object 40 is provided with the battery 48. The driver 44 is assumed to be configured by a motor that operates on power from the battery 48.

As illustrated in FIG. 1, the mobile object 40 further includes a non-essential mobile object controller 46. The mobile object controller 46 controls at least one component of the mobile object 40, such as the body 42 or driver 44 of the mobile object 40. The mobile object controller 46 may acquire destination information specifying a destination from the management apparatus 10 and control the driver 44 to travel autonomously based on the destination information. The mobile object 40 may acquire control information indicating the timing at which to start or stop traveling, the travel speed, or the like from the management apparatus 10 and control the driver 44 to travel based on the control information. In a case in which a delivery article 50 is stored in the body 42, the mobile object controller 46 may output information identifying the stored delivery article 50 to the management apparatus 10. In a case in which a delivery article 50 is removed from the body 42, the mobile object controller 46 may output information identifying the removed delivery article 50 to the management apparatus 10.

The mobile object controller 46 may be configured to include at least one processor. The mobile object controller 46 may be configured to include one or more dedicated circuits instead of the processor, or may be configured to include a dedicated circuit along with the processor. The mobile object 40 may be configured to include a memory. The memory of the mobile object 40 may be configured to be identical or similar to the memory of the management apparatus 10. The mobile object 40 may be configured to include an I/F or a communication module. The I/F or communication module of the mobile object 40 may be configured to be identical or similar to the I/F or communication module of the management apparatus 10.

The mobile object 40 may be configured to include a positional information detector that acquires the positional information for the mobile object 40 itself. The mobile object 40 may output the positional information for the mobile object 40 itself to the management apparatus 10. The positional information detector may be configured to include a receiver compliant with a satellite positioning system. The receiver compliant with the satellite positioning system may include, for example, a Global Positioning System (GPS) receiver.

The number of mobile objects 40 managed by the management system 1 may be two or more. The mobile object 40 is not limited to the configuration illustrated in FIG. 2 but may be configured in a variety of other ways to store the delivery article 50 and move.

The mobile object controller 46 may acquire detection results regarding the state of the mobile object 40 from various sensors installed in the mobile object 40. The mobile object controller 46 may acquire the state of the mobile object 40 based on sensor detection results. The state of the mobile object 40 may, for example, include the state of charge (SOC: State of Charge) or state of health (State of Health) of the battery 48. The state of the mobile object 40 may include the distance traveled by the mobile object 40 since the start of operation. The state of the mobile object 40 may include the distance traveled after maintenance. The state of the mobile object 40 may include the number of days or elapsed time after maintenance. The state of the mobile object 40 may include information, recorded for each component, on the distance traveled after replacement of the component. The state of the mobile object 40 may include information, recorded for each component, on the number of days or elapsed time after replacement of the component. The mobile object controller 46 may output information representing the state of the mobile object 40 to the management apparatus 10.

<Terminal Apparatus 20>

The management system 1 further includes a non-essential terminal apparatus 20. The terminal apparatus 20 may accept input of information, from the user who ships the delivery article 50, specifying the place or time to ship the delivery article 50 and may output the inputted information to the management apparatus 10. The terminal apparatus 20 may accept input of information, from the user who receives the delivery article 50, specifying the place or time to receive the delivery article 50 and may output the inputted information to the management apparatus 10. The terminal apparatus 20 may acquire information about the delivery status of the delivery article 50 from the management apparatus 10 and notify the user who shipped the delivery article 50 or the user who is to receive the delivery article 50 of the delivery status.

The terminal apparatus 20 may be configured to include one or more processors or one or more dedicated circuits. The terminal apparatus 20 may be configured to include a memory. The memory of the terminal apparatus 20 may be configured to be identical or similar to the memory of the management apparatus 10. The terminal apparatus 20 may be configured to include an I/F or a communication module. The I/F or communication module of the terminal apparatus 20 may be configured to be identical or similar to the I/F or communication module of the management apparatus 10.

The terminal apparatus 20 may be configured to include an input device for receiving inputs, such as information or data, from the user. The input device may be configured to include the various devices described as the I/F 14. The terminal apparatus 20 may be configured to include an output device that outputs information, data, or the like to the user. The output device may be configured to include the various devices described as the I/F 14.

The number of terminal apparatuses 20 included in the management system 1 is not limited to one and may be two or more. The terminal apparatus 20 may be configured as a mobile terminal, such as a smartphone or a tablet, or a Personal Computer (PC), such as a notebook PC or a tablet PC. The terminal apparatuses 20 are not limited to the above examples and may include various devices.

(Operation Example of Management System 1)

In the management system 1 according to the present embodiment, the controller 12 of the management apparatus 10 manages the operation of each mobile object 40 in a plurality of mobile objects 40. The controller 12 allocates the mobile object 40 for the tasks of storing the delivery article 50 at the delivery source and delivering the delivery article 50 to the delivery destination. The controller 12 allocates the mobile object 40 for delivery based on delivery information. The delivery information may include information about the delivery article 50 or about the delivery source or delivery destination.

In a case in which the mobile object 40 is not storing any delivery articles 50 or has the capacity to store another delivery article 50, the controller 12 designates the delivery source of the delivery article 50 as the destination of the mobile object 40 so that the mobile object 40 stores the delivery article 50. In a case in which the mobile object 40 has stored the delivery article 50, the controller 12 designates the delivery destination of the delivery article 50 as the destination of the mobile object 40 so that the mobile object 40 delivers the stored delivery article 50.

The delivery source includes the location from which the delivery article 50 is shipped. The delivery article 50 may be shipped from the user, such as a corporation or individual, or from a distribution center or the like that has collected the delivery article 50. The delivery destination includes the location at which the delivery article 50 is to be received. The delivery article 50 may be received by a user, such as a corporation or individual, or by a distribution center or the like that collects the delivery article 50. These examples are not limiting, and the delivery source or destination may include a variety of locations.

Deliveries are delayed when maintenance on the mobile object 40 becomes necessary during delivery. Delays in delivery reduce the delivery efficiency. The controller 12 determines a mobile object 40 to allocate for delivery while taking into consideration the possibility that maintenance on the mobile object 40 will become necessary during delivery. In this way, the delivery efficiency by the mobile object 40 is maintained or enhanced.

The controller 12 may plan the operation of the mobile object 40 so that the mobile object 40 is maintained in advance, taking into consideration the possibility that maintenance on the mobile object 40 will become necessary during delivery. In this way, the interval between the times when the mobile object 40 is maintained can be lengthened. In other words, the maintenance frequency can be reduced. As a result, a balance can be achieved between delivery efficiency and frequency of maintenance.

In a case in which maintenance becomes necessary, the mobile object 40 may receive maintenance at the facility where the maintenance work is performed. In a case in which maintenance becomes necessary, the mobile object 40 may travel by itself to the facility where the maintenance work is to be performed, or the mobile object 40 may be transported to the facility where the maintenance work is to be performed by an apparatus that transports mobile objects 40 or by another mobile object 40.

The controller 12 may allocate a mobile object 40, for delivery, that can travel on its own to the location for receiving maintenance in a case in which maintenance on the mobile object 40 becomes necessary during delivery. In this way, delivery delays can be reduced. As a result, a decrease in the delivery efficiency can be avoided.

The controller 12 may acquire information about the state of the mobile object 40. Based on information about the state of the mobile object 40, the controller 12 may estimate the probability that maintenance on the mobile object 40 will become necessary during delivery in a case in which the mobile object 40 is allocated for delivery. The controller 12 may determine to allocate the mobile object 40 for delivery based on the estimated probability that maintenance on the mobile object 40 will become necessary during delivery. The controller 12 may estimate the probability that maintenance will become necessary during delivery for a plurality of mobile objects 40. The controller 12 may select the mobile object 40 for delivery from among the plurality of mobile objects 40 based on the estimated probability that maintenance on each mobile object 40 will become necessary during delivery. The controller 12 may allocate, for delivery, a mobile object 40 with a low probability that maintenance will become necessary during delivery.

The controller 12 may plan the operation of the mobile object 40 so that the mobile object 40 is maintained in advance, taking into consideration the probability that maintenance on the mobile object 40 will become necessary during delivery. The controller 12 may plan maintenance on the mobile object 40 in a case in which the probability that maintenance on the mobile object 40 will become necessary during delivery is equal to or greater than a predetermined value. In this way, the interval between times when maintenance is performed on the mobile object 40 can be longer than when maintenance is simply planned on a regular basis without consideration for the state of the mobile object. In other words, the maintenance frequency can be reduced. As a result, a balance can be achieved between delivery efficiency and frequency of maintenance.

The controller 12 may estimate the probability that maintenance on the mobile object 40 will become necessary during delivery based on the state of the battery 48 in the mobile object 40. The controller 12 can estimate that the probability that maintenance on the mobile object 40 will become necessary during delivery is lower as the value of the SOC or SOH of the battery 48 in the mobile object 40 is higher.

The controller 12 may estimate the probability that maintenance on the mobile object 40 will become necessary during delivery based on the distance traveled by the mobile object 40 since the start of operation. The controller 12 can estimate that the probability that maintenance on the mobile object 40 will become necessary during delivery is lower as the distance traveled by the mobile object 40 since the start of operation is shorter. In other words, the newer the mobile object 40, the lower the probability that maintenance on the mobile object 40 will become necessary during delivery.

The controller 12 may estimate the probability that maintenance on the mobile object 40 will become necessary during delivery based on the distance traveled by the mobile object 40 after maintenance. The controller 12 can estimate that the probability that maintenance on the mobile object 40 will become necessary during delivery is lower as the distance traveled by the mobile object 40 after maintenance is shorter. The controller 12 may also estimate the probability that maintenance on the mobile object 40 will become necessary during delivery based on the distance traveled by the mobile object 40 after a component is replaced. The controller 12 can estimate that the probability that maintenance on the mobile object 40 will become necessary during delivery is lower as the distance traveled by the mobile object 40 after a component is replaced is shorter.

The controller 12 may estimate the probability that maintenance on the mobile object 40 will become necessary during delivery based on the number of days or elapsed time after maintenance on the mobile object 40. The controller 12 can estimate that the probability that maintenance on the mobile object 40 will become necessary during delivery is lower as the number of days or elapsed time after maintenance on the mobile object 40 is shorter. The controller 12 may estimate the probability that maintenance on the mobile object 40 will become necessary during delivery based on the number of days or elapsed time after replacement of a component of the mobile object 40. The controller 12 can estimate that the probability that maintenance on the mobile object 40 will become necessary during delivery is lower as the number of days or elapsed time after replacement of a component of the mobile object 40 is shorter.

The probability that maintenance on the mobile object 40 will become necessary during delivery can be determined by the delivery route from the delivery source to the delivery destination. The controller 12 may estimate the probability that maintenance will become necessary during delivery based on the delivery route when the mobile object 40 is allocated for delivery and may allocate the mobile object 40 based on the result of estimation. For example, the longer the delivery route, the higher the probability that maintenance on the mobile object 40 will become necessary during delivery. Furthermore, the greater the difference in elevation along the delivery route, the higher the probability that maintenance on the mobile object 40 will become necessary during delivery. Also, the greater the number of stops the mobile object 40 makes on the delivery route, the higher the probability that maintenance on the mobile object 40 will become necessary during delivery.

As a result of maintenance on the mobile object 40 becoming necessary at a location far from the location for receiving maintenance, the time it takes until the mobile object 40 receives maintenance may grow longer. The greater the distance between the location at which maintenance on the mobile object 40 becomes necessary and the location for receiving maintenance, the more likely a decrease in delivery efficiency becomes. The controller 12 may allocate a mobile object 40, for which the probability that maintenance will become necessary during delivery is low, for delivery with a greater distance from the delivery route to the location for receiving maintenance. In other words, the mobile object 40 may be allocated so that the greater the distance from the delivery route to the location for receiving maintenance, the lower the probability that maintenance on the mobile object 40 will become necessary during delivery. In this way, a reduction in delivery efficiency can be prevented.

The delivery efficiency may be reduced as a result of maintenance on the mobile object 40 becoming necessary during delivery in an area with high delivery frequency. The controller 12 may allocate a mobile object 40, for which the probability that maintenance will become necessary during delivery is low, for delivery in an area with a high delivery frequency. In other words, the mobile object 40 may be allocated so that the higher the delivery frequency in the area to which the mobile object 40 is allocated for delivery, the lower the probability that maintenance on the mobile object 40 will become necessary during delivery. In this way, a reduction in delivery efficiency can be prevented.

The delivery delay is more likely to exceed the allowable delay as a result of maintenance becoming necessary during delivery by a mobile object 40 allocated for delivery with a short allowable delivery delay. Delivery delays reduce convenience for users. The controller 12 may allocate a mobile object 40, for which the probability that maintenance will become necessary during delivery is low, for delivery with a short allowable delivery delay. In this way, the delivery delay is less likely to exceed the allowable delay. User convenience can therefore be improved.

Conversely, the controller 12 may allocate a mobile object 40 scheduled for maintenance for delivery in an area with a low delivery frequency or for delivery with a long allowable delivery delay. In this way, maintenance on the mobile object 40 can be performed after maintenance on the mobile object 40 becomes necessary. As a result, the frequency of maintenance on the mobile object 40 is reduced without a decrease in delivery efficiency. In other words, a balance can be achieved between the frequency of maintenance and delivery efficiency.

<Example Procedures for Management Method>

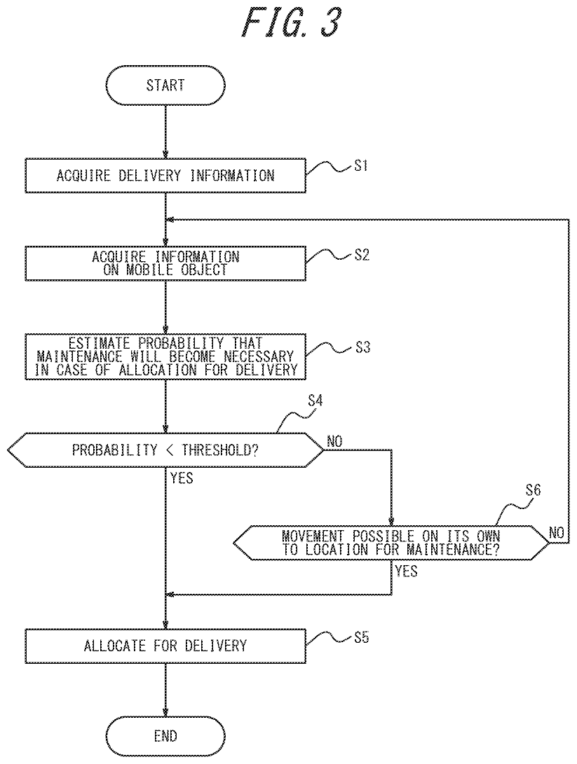

As described above, the controller 12 of the management apparatus 10 according to the present embodiment allocates the mobile object 40 for delivery while taking into consideration the possibility that maintenance on the mobile object 40 will become necessary during delivery. The controller 12 may, for example, perform a management method including the procedures of the flowchart illustrated in FIG. 3. The management method may be implemented as a management program to be executed by the controller 12. The management program may be stored on a non-transitory computer readable medium.

The controller 12 acquires delivery information (step S1). The controller 12 acquires information about the mobile object 40 (step S2). The controller 12 estimates the probability that maintenance will become necessary during delivery in a case in which the mobile object 40 is allocated for delivery (step S3).

The controller 12 determines whether the probability estimated in step S3 is less than a threshold (step S4). In a case in which the probability is less than the threshold (step S4: YES), the controller 12 allocates that mobile object 40 to delivery (step S5). After performing the procedure of step S5, the controller 12 can end the execution of the procedures in the flowchart of FIG. 3.

In a case in which the probability is not less than the threshold (step S4: NO), that is, in a case in which the probability is equal to or greater than the threshold, the controller 12 determines whether the mobile object 40 can move to the location for maintenance on its own (step S6). In a case in which the mobile object 40 can move to the location for maintenance on its own (step S6: YES), the controller 12 proceeds to step S5 and allocates the mobile object 40 for delivery. In a case in which the mobile object 40 cannot move to the location for maintenance on its own (step S6: NO), the controller 12 returns to the procedure in step S2 and acquires information on another mobile object 40.

The controller 12 may acquire information on a plurality of mobile objects 40 in the procedure of step S2. The controller 12 may estimate the probability that maintenance will become necessary during delivery in a case in which the mobile object 40 is allocated for each mobile object 40 in the procedure of step S3. The controller 12 may select the mobile object 40 to allocate for delivery based on the probability estimated for each mobile object 40 in the procedure of step S4.

As described above, according to the management system 1, the management apparatus 10, and management method of the present embodiment, the mobile object 40 to be allocated for delivery is determined taking into consideration the possibility that maintenance on the mobile object 40 will become necessary during delivery. In this way, the delivery efficiency by the mobile object 40 is maintained or enhanced. The interval between the times when the mobile object 40 is maintained can also be lengthened. In other words, the maintenance frequency can be reduced. As a result, a balance can be achieved between delivery efficiency and frequency of maintenance.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A management apparatus comprising a controller configured to manage a mobile object that delivers articles, wherein
the controller is configured to determine the mobile object to allocate for delivery while taking into consideration a possibility that maintenance on the mobile object will become necessary during delivery.

2. The management apparatus according to claim 1, wherein the controller is configured to allocate the mobile object, for delivery, that can travel on its own to a location for receiving maintenance in a case in which maintenance on the mobile object becomes necessary.

3. The management apparatus according to claim 1, wherein the controller is configured to allocate the mobile object for delivery based on an estimated probability that maintenance on the mobile object will become necessary during delivery.

4. The management apparatus according to claim 3, wherein the controller is configured to allocate the mobile object, for which the probability that maintenance will become necessary during delivery is low, for delivery with a greater distance from a delivery route to a location for receiving maintenance.

5. The management apparatus according to claim 3, wherein the controller is configured to allocate the mobile object, for which the probability that maintenance will become necessary during delivery is low, for delivery in an area with a high delivery frequency.

6. The management apparatus according to claim 3, wherein the controller is configured to allocate the mobile object, for which the probability that maintenance will become necessary during delivery is low, for delivery with a short allowable delivery delay.

7. The management apparatus according to claim 4, wherein the controller is configured to allocate, for delivery, the mobile object with a short distance traveled as the mobile object for which the probability that maintenance will become necessary during delivery is low.

8. The management apparatus according to claim 7, wherein the controller is configured to allocate the mobile object, for delivery, with a short distance traveled after replacement of at least one component of the mobile object.

9. The management apparatus according to claim 3, wherein the controller is configured to allocate the mobile object scheduled for maintenance for delivery in an area with a low delivery frequency or for delivery with a long allowable delivery delay.

10. A management system comprising:
the management apparatus according to claim 1; and
a mobile object configured to deliver articles.

11. A management method comprising:
determining, by a management apparatus configured to manage a mobile object that delivers articles, the mobile object to allocate for delivery while taking into consideration a possibility that maintenance on the mobile object will become necessary during delivery.

12. The management method according to claim 11, further comprising allocating the mobile object, for delivery, that can travel on its own to a location for receiving maintenance in a case in which maintenance on the mobile object becomes necessary.

13. The management method according to claim 11, further comprising allocating the mobile object for delivery based on an estimated probability that maintenance on the mobile object will become necessary during delivery.

14. The management method according to claim 13, further comprising allocating the mobile object, for which the probability that maintenance will become necessary during delivery is low, for delivery with a greater distance from a delivery route to a location for receiving maintenance.

15. The management method according to claim 13, further comprising allocating the mobile object, for which the probability that maintenance will become necessary during delivery is low, for delivery in an area with a high delivery frequency.

16. The management method according to claim 13, further comprising allocating the mobile object, for which the probability that maintenance will become necessary during delivery is low, for delivery with a short allowable delivery delay.

17. The management method according to claim 14, further comprising allocating, for delivery, the mobile object with a short distance traveled as the mobile object for which the probability that maintenance will become necessary during delivery is low.

18. The management method according to claim 17, further comprising allocating the mobile object, for delivery, with a short distance traveled after replacement of at least one component of the mobile object.

19. The management method according to claim 13, further comprising allocating the mobile object scheduled for maintenance for delivery in an area with a low delivery frequency or for delivery with a long allowable delivery delay.

20. A non-transitory computer readable medium storing a management program configured to cause a management apparatus, configured to manage a mobile object that delivers articles, to determine the mobile object to allocate for delivery while taking into consideration a possibility that maintenance on the mobile object will become necessary during delivery.
